(19) United States
(12) Patent Application Publication
(10) Pub. No.: US 2016/0346146 A1
(43) Pub. Date: Dec. 1, 2016

(54) HEAD SUPPORT APPARATUS

(71) Applicant: OAKFIELD ENGINEERING LIMITED, Maghera County Londonderry (GB)

(72) Inventor: Joseph O'Loughlin, Maghera, County Londonderry (GB)

(21) Appl. No.: 15/116,760

(22) PCT Filed: Feb. 3, 2015
(86) PCT No.: PCT/EP2015/052220

§ 371 Date: Aug. 4, 2016

(30) Foreign Application Priority Data
Feb. 5, 2014 (GB) 1401969.9

(51) Int. Cl. A61G 7/07; A61G 5/12

(52) U.S. Cl. CPC A61G 7/072; A61G 5/12; A61G 2005/121

(57) ABSTRACT

A head support apparatus for attachment to a wheelchair or bed includes a headband or harness to be fitted to the patient's head, and a lifting device attached to the headband or harness for lifting and supporting the patient's head, the lifting device being adapted to periodically raise and support the patient's head and subsequently allow the patient's head to slump forwards.

### CROSS REFERENCE TO RELATED APPLICATIONS

The present application is a §371 national stage of International Application PCT/EP2015/052220, filed Feb. 3, 2015, which claims the priority benefit of U.K. patent application Ser. No. 1401969.9, filed Feb. 5, 2014, both of which are hereby incorporated herein by reference in their entireties.

### FIELD OF THE INVENTION

This invention relates to a head support apparatus for attachment to a wheelchair or bed for preventing the formation of sores between the patient's neck and chin.

### BACKGROUND OF THE INVENTION

Many infirm, paralyzed, or elderly persons have inadequate use or control of their neck muscles. When such persons are seated in a wheelchair, their weak neck muscles often allow their head to fall forwards such that their chin rests upon their chest. This, combined with feeding and drinking difficulties, can lead to the formation of damp and unsanitary conditions between the patient's neck and chin, leading to the formation of sores.

Attempts have been made to provide head supporting strap arrangements that can be worn around the head to maintain the head in an upright position. However, the constant pressure applied to the skin by such strap arrangements can lead to pressure sores. WO 95/01114 discloses a head support for a wheelchair bound patient including a headband attached to a frame on the wheelchair via an adjustable cord, whereby the length of the cord can be manually adjusted to progressively lift the patient's head. However, this arrangement is not able to automatically lift and lower the patient's head. It is purely a manually operable head supporting device.

### SUMMARY OF THE INVENTION

According to the present invention there is provided a head support apparatus for attachment to a wheelchair or bed, the apparatus including a headband or harness to be fitted to the patient's head and lifting means attached to the headband or harness for lifting and supporting the patient's head, the lifting means being adapted to periodically raise and support the patient's head and subsequently allow the patient's head to slump forwards.

The invention allows the patient's head to be raised and supported to reduce the formation of sores between the patient's neck and chin while avoiding the formation of pressure sores on the head which might othewise form if the patient's head were supported by the headband or harness for long periods of time. The periodic raising and lowering of the patient's head may also provide therapeutic excercise for the patient's neck.

The lifting means may include a crank arm or wheel, to which the headband or harness may be attached at a location offset from the centre of rotation of the crank arm or wheel.

The crank arm or wheel may be rotated or turned by a motor under the control of a controller. The contoller may be programmed to periodically raise and lower the patient's head at predetermined intervals.

The headband or harness may be attached to the crank arm or wheel via an elongate rope, cord or strap.

Optionally, the lifting means is mounted within a housing, the housing being adapted to be affixed to a wheelchair or bed. The housing may include a control panel having user controls for controlling the operation of the lifting means.

In another embodiment the lifting means may be adapted to rotate the head from side to side, for example by alternately raising and lower either side of the head or by raising and lowering either side of the head out of phase with one another. Such rotation may provide beneficial excercise for the neck muscles. This may be achieved by connecting separate ropes, cords or straps on each side of the headband or harness, connecting each rope, cord or strap to a separate crank arm or wheel which may be rotated out of phase with one another by a single motor or which may be rotated independently by separate motors.

These and other objects, advantages and features of the invention will become apparent upon review of the following specification in conjunction with the drawings.

### BRIEF DESCRIPTION OF THE DRAWINGS

A head support apparatus in accordance with an embodiment of the present invention will now be described, by way of example only, with reference to the accompanying drawings, in which:—

FIG. 1 is a side view of a head support apparatus according to an embodiment of the present invention;

FIG. 2 is a front view of the head support apparatus of FIG. 1;

FIG. 3 is a perpsective view of the head support apparatus of FIG. 1;

FIG. 4 is a detailed view of the head support apparatus of FIG. 1; and

FIG. 5 is a perspective view of the head support apparatus of FIG. 1 with the outer cover removed.

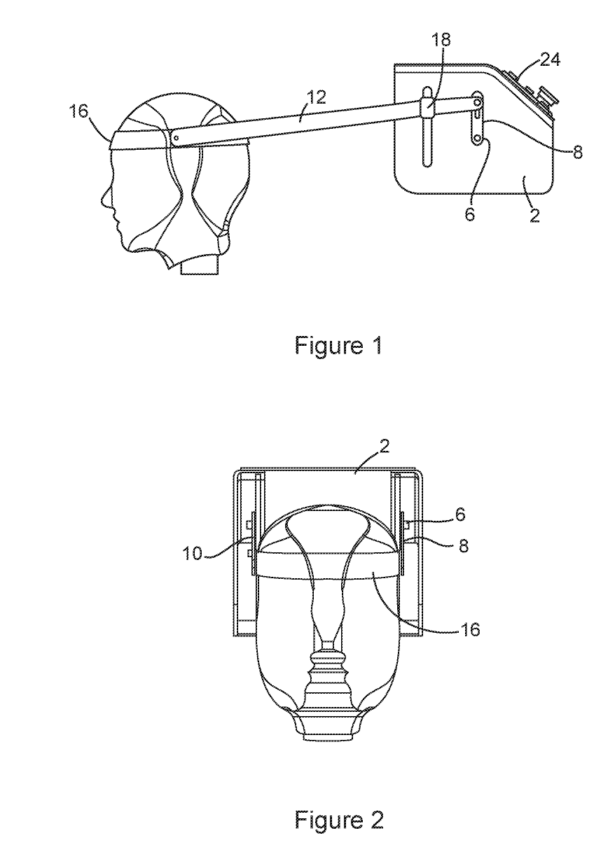

### DESCRIPTION OF THE PREFERRED EMBODIMENT

A illustrated in the drawings, a head support apparatus in accordance with an embodiment of the present invention includes a housing 2 adapted to be mounted onto a wheelchair or bed within which a patient may be confined.

A lifting means or device is mounted in the housing 2 in the form of a motor (4, FIG. 5) drivingly coupled to a drive shaft 6, such as via suitable gearing, the drive shaft 6 extending transverse to the housing to extend through apertures on either side of the housing. A pair of parallel crank arms 8,10 are mounted on either end of the drive shaft to be located on either side of the housing 2.

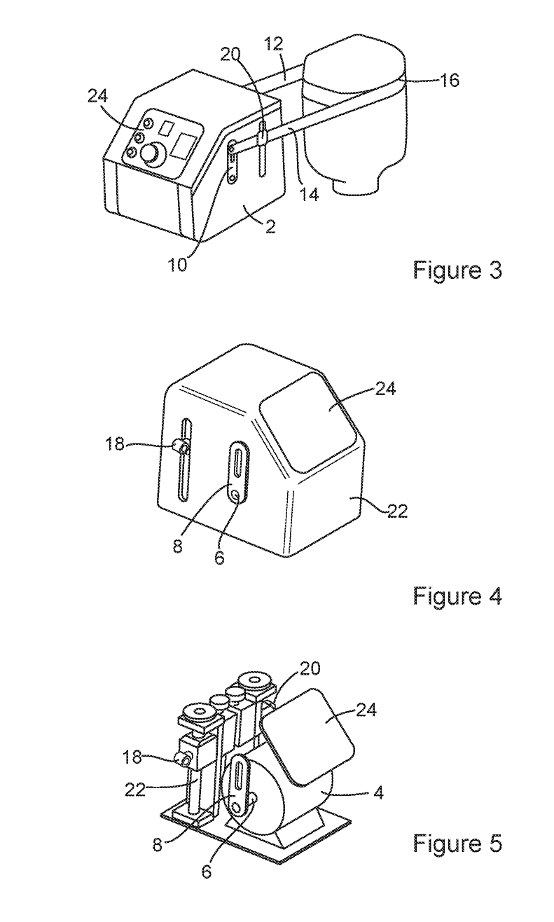

Each crank arm 8,10 is coupled to a strap 12,14 attached to a respective side of a harness or headband 16 to be fitted around the head of a patient, as shown in FIGS. 2 to 3. The straps 12,14 are mounted on either side of the harness or headband 16 such that the patient's head is supported in both a vertical and a horizontal plane. A slot is provided in each crank arm 8,10 such that the distance between the point and which the respective strap 12,14 is coupled to the crank arm 8,10 and the rotational axis of the crank arm 8,10 can be adjusted to adjust the stroke or range of motion of the patient's head between raised and lowered positions. It is envisaged that each crank arm 8,10 may be replaced by respective discs to which the straps 12,14 may be respectively attached at locations spaced from the centre of rotation of each disc.

The straps 12,14 pass through respective guides 18,20 provided on either side of the housing 2. As shown in FIG. 5, the height of the guides 18,20 may be adjusted to suit different sized patients. In the embodiment shown, the guides 18,20 are mounted on threaded support posts 22.

A programmable controller, incorporating a timer, is associated with the motor for periodically operating the motor at predetermined intervals, such that the motor rotates the crank arms, raising and lowering the head of the patient.

A control panel 24 is provided on a rear side of the housing enabling a user to control the operation of the controller and thus the lifting means.

In use, the harness or headband 16 is attached to the patient and the control panel 24 is used to programme the controller to enable the lifting means to periodically lift and support the patient's head, holding the patient's chin away from the patient's neck, and periodically lower the patient's head, releiveing pressure from the harness or headband.

Each strap 12,14 may be connected to a respective crank arm 8,10 such the straps 12,14 pull against the harness or headband 16 out of phase with one another, for example by mounting the cranks 8,10 out of phase with one another on the drive shaft 6, such as 180° out of phase with one another, such that operation of the motor 4 causes the head to rotate from side to side. Such movement may provide beneficial excercise for the neck. Alternatively each strap 12,14 may be connected to a respective crank arm 8,10 driven by a respective and separate motor so that the two cranks arms 8,10 can be rotated independently under the control of the controller.

The invention is not limited to the embodiment(s) described herein but can be amended or modified without departing from the scope of the present invention, which is intended to be limited only by the scope of the appended claims as interpreted according to the principles of patent law including the doctrine of equivalents.

1. A head support apparatus for attachment to a wheelchair or bed, the apparatus comprising a headband or harness to be fitted to a patient's head, and lifting device attached to the headband or harness for lifting and supporting the patient's head, the lifting device being adapted to periodically raise and support the patient's head and subsequently allow the patient's head to slump forwards.

2. A head support apparatus as claimed in claim 1, wherein the lifting device comprises a crank arm or wheel, to which the headband or harness is attached at a location offset from the centre of rotation of the crank arm or wheel.

3. A head support apparatus as claimed in claim 2, further comprising a motor and a controller, wherein the motor is operable to rotate or turn the crank arm or wheel under the control of the controller.

4. A head support apparatus as claimed in claim 3, wherein the contoller is programmed to periodically raise and lower the patient's head at predetermined intervals.

5. A head support apparatus as claimed in claim 2, wherein the headband or harness is attached to the crank arm or wheel via an elongate rope, cord or strap.

6. A head support apparatus as claimed in claim 1, wherein the lifting device is mounted within a housing, the housing being adapted to be affixed to a wheelchair or bed.

7. A head support apparatus as claimed in claim 6, wherein the housing includes a control panel having user controls for controlling the operation of the lifting device.

8. A head support apparatus as claimed in claim 1, wherein the lifting device is adapted to rotate the patient's head from side to side.

9. A head support apparatus as claimed in claim 8, wherein the lifting device is adapted to alternately or indepedently raise and lower either side of the patient's head.

10. A head support apparatus as claimed in claim 9, wherein the lifting device is adapted to raise and lower the sides of the patient's head out of phase with one another.

11. A head support apparatus as claimed in claim 1, comprising a housing, the lifting device comprising pair of crank arms mounted on either side of the housing, each crank arm being coupled to a respective strap attached to a respective side of the harness or headband such that the patient's head is supported in both a vertical and a horizontal plane, wherein the crank arms are rotatably driven to raise and lower the patient's head.

12. A head support apparatus as claimed in claim 11, wherein the crank arms are mounted on a common drive shaft extending through the housing.

13. A head support apparatus as claimed in claim 12, wherein the lifting device is adapted to rotate the patient's head from side to side, and wherein the crank arms are angularly offset from one another such that rotation of the crank arms causes the sides of the patient's head to be raised and lowered out of phase with one another.

14. A head support apparatus as claimed in claim 13, wherein the crank arms are arranged 180° out of phase with one another.

15. A head support apparatus as claimed in claim 11, further comprising a separate drive device coupled to respective ones of the crank arms, and a common controller operable to activate the drive devices, wherein crank arms can be rotated independently from one another under the control of the common controller.

16. A head support apparatus as claimed in claim 11, wherein a slot is provided in each crank arm such that the distance between the point and which the respective strap is coupled to the crank arm and the rotational axis of the crank arm can be adjusted to adjust the stroke or range of motion of the patient's head between raised and lowered positions.

17. A head support apparatus as claimed in claim 11, wherein the straps pass through respective guides provided on either side of the housing.

18. A head support apparatus as claimed in claim 17, wherein the position of each guide on the housing is vertically adjustable to suit different sized patients.
